(19) United States
(12) Patent Application Publication
(10) Pub. No.: US 2011/0204198 A1
(43) Pub. Date: Aug. 25, 2011

(54) METHOD AND APPARATUS FOR INSTALLING A POST MOUNT

(76) Inventors: Steven J. Leary, Barnegat, NJ (US); Benjamin Yin, Hong Kong (HK)

(21) Appl. No.: 12/711,841

(22) Filed: Feb. 24, 2010

(51) Int. Cl. F16M 13/00; B23P 11/00

(52) U.S. Cl. 248/346.03; 248/346.01; 29/525.01

(57) ABSTRACT

In one embodiment, the invention is a method and apparatus for installing a post mount. In one embodiment, a support block for use in securing a post mount includes a body having a first end and a second end and an adjustment mechanism formed integrally with the first end of the body, by which a vertical orientation of a post mount incorporating the support block can be adjusted.

### FIELD OF THE INVENTION

The present invention relates generally to railing systems and relates more specifically to support hardware for use in railing installations.

### BACKGROUND OF THE DISCLOSURE

Post mounts are frequently used in the construction of decks, porches, stairs, and other structures that include railings. FIG. 1, for example, is a schematic illustration of a portion of an exemplary railing system 100, including a post mount 108. The railing system 100 comprises a railing 102, a support surface 104, and a plurality of posts 106₁-106ₙ (hereinafter collectively referred to as “posts 106”). Generally, the rail 102 is supported in a spaced-apart relation relative to the support surface 104 by the posts 106.

In order to mount the posts 106 to the support surface 104 (which may comprise, for example, wood or concrete) in a substantially invisible manner (i.e., little or no outwardly visible hardware), post mounts are often first installed in the support surface 104. For example, the post 106₁ is mounted to the support surface via a post mount 108 (illustrated in phantom). Specifically, the post mount 108 is fastened to the support surface 104 in a secure manner, and the hollow post 106₁ is then slipped over the post mount 108, like a sleeve. In this manner, the post 106₁ is supported securely by the support surface 104 and in turn provides secure support for the railing 102.

The railing system 100 is most structurally sound when the posts 106 are oriented plumb with the vertical direction (e.g., substantially perpendicular to the support surface 104). In order to orient a post 106 plumb in the vertical direction, the post 106 may need to be moved or adjusted in a desired direction. Conventionally, this involves placing wedge shims under the flange at the bottom of the post mount 108 or a using a series of leveling screws that are tightened and/or loosened in a specific order. Such techniques, however, may be tedious and imprecise. In addition, if the post 106 shifts after installation (e.g., due to settling or concrete uplift), the entire affected portion of the railing system 100 must be taken apart, adjusted, and re-assembled.

### SUMMARY OF THE INVENTION

In one embodiment, the invention is a method and apparatus for installing a post mount. In one embodiment, a support block for use in securing a post mount includes a body having a first end and a second end and an adjustment mechanism formed integrally with the first end of the body, by which a vertical orientation of a post mount incorporating the support block can be adjusted.

### BRIEF DESCRIPTION OF THE DRAWINGS

The teachings of the present invention can be readily understood by considering the following detailed description in conjunction with the accompanying drawings, in which:

FIG. 1 is a schematic illustration of a portion of an exemplary railing system, including a post mount;

FIG. 2 is an isometric view of one embodiment of a post mount, according to the present invention;

FIG. 3 is an exploded view of the support pipe and support block illustrated in FIG. 2.

FIG. 4 is a cross sectional view of the support block, taken along line A-A′ of FIG. 2;

FIG. 5 is a plan view illustrating one embodiment of the first plate illustrated in FIGS. 3-4; and

FIG. 6 is a flow diagram illustrating one embodiment of a method for adjusting a post mount so that a post placed over the post mount is plumb in the vertical direction.

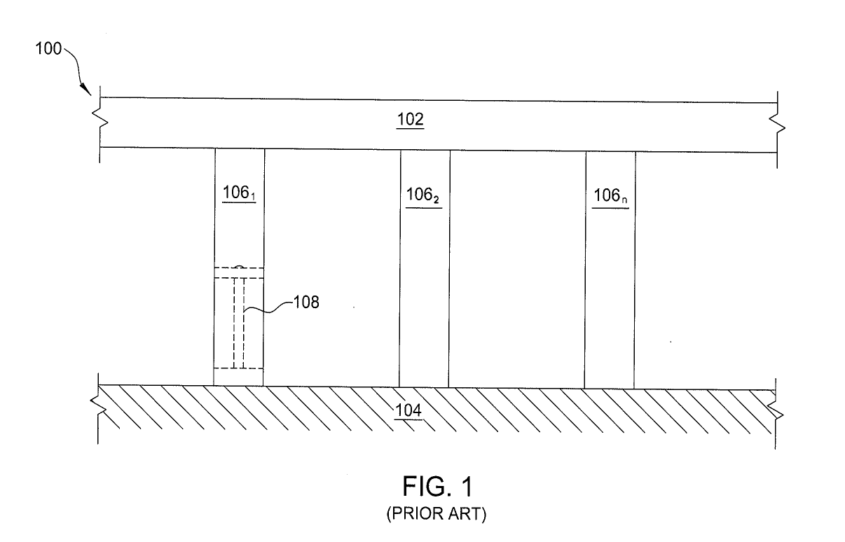

To facilitate understanding, identical reference numerals have been used, where possible, to designate identical elements that are common to the figures.

### DETAILED DESCRIPTION

In one embodiment, the invention is a method and apparatus for installing a post mount. Embodiments of the present invention allow a post to be leveled and plumbed quickly and easily after being installed over a post mount. Moreover, the post can be easily adjusted if it becomes out of plumb after installation (e.g., due to settling or uplift of the support surface).

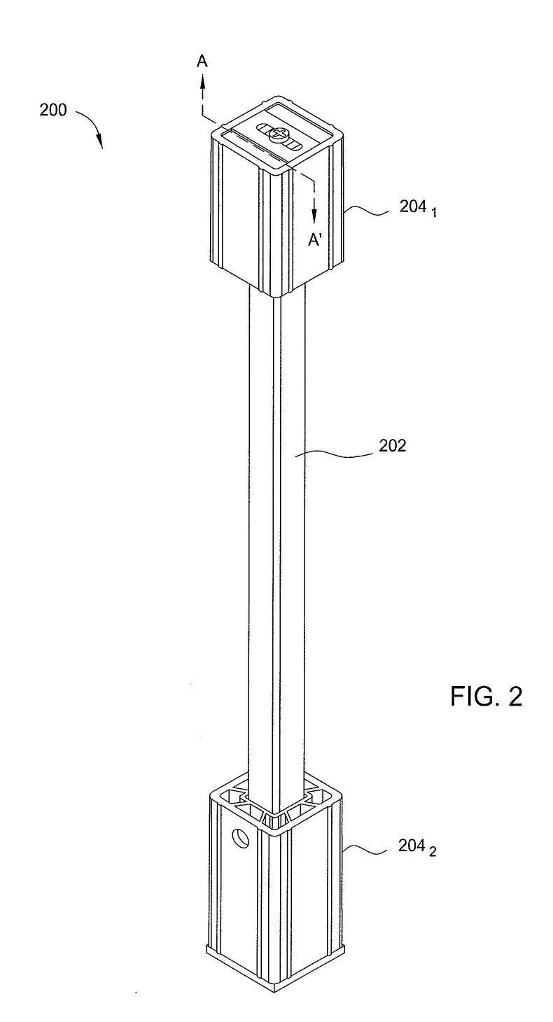

FIG. 2 is an isometric view of one embodiment of a post mount 200, according to the present invention. The post mount 200 comprises a support pipe 202 supported between a first support block 204₁ and a second support block 204₂ (hereinafter collectively referred to as “support blocks 204”). In installation, the second support block 204₂ is mounted to a support surface (e.g., a wood or concrete support surface) such that a hollow post may be slipped over the post mount 200, as described above. The first support block 204₁ is mounted to a railing after the post is slipped over the post mount 200. The outer perimeters of the support blocks 204 are sized to be slightly smaller than the inner perimeter of a post slipped thereover, such that the post is snugly supported by the support blocks 204.

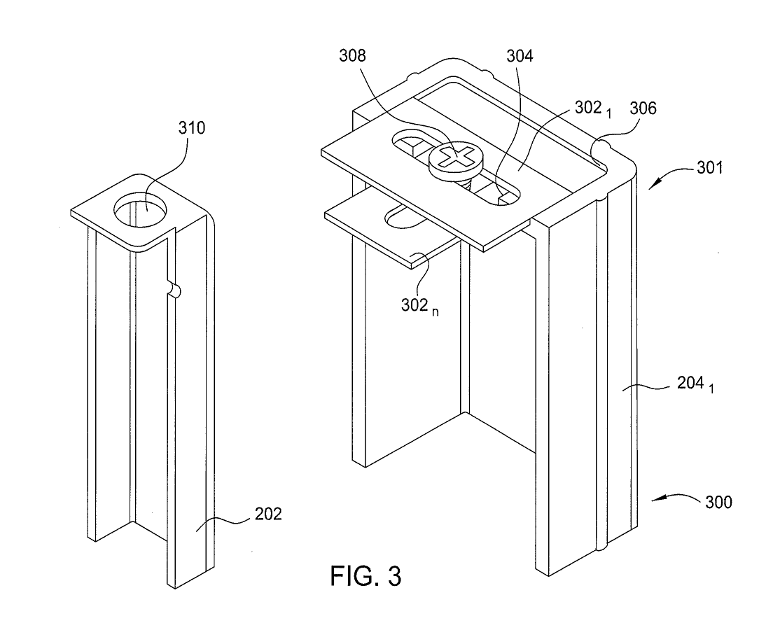

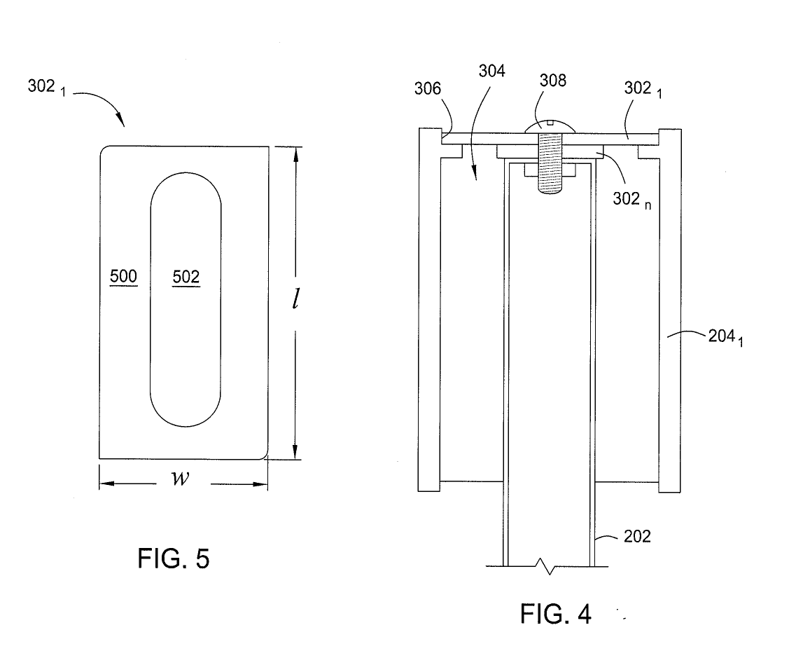

FIG. 3 is an exploded view of the support pipe 202 and support block 204 illustrated in FIG. 2. FIG. 4 is a cross sectional view of the support block 204, taken along line A-A′ of FIG. 2. Specifically, the support block 204 illustrated in FIGS. 3 and 4 corresponds to the first support block 204₁ illustrated in FIG. 2 (i.e., a “top” support block that is designed to be mounted to a railing). As illustrated, the first support block 204₁ is an elongated block having a substantially square cross-section. In one embodiment, the first support block 204₁ is formed of a rigid plastic or composite, such as polypropylene, polyethylene or the like.

Referring simultaneously to FIGS. 3 and 4, the first support block 204₁ comprises a substantially hollow body. The first support block 204₁ has a larger perimeter than the support pipe 202, such that the support pipe 202 fits within the hollow interior of the first support block 204₁. A first end 300 of the first support block 204₁ is substantially open and is designed to receive the support pipe 202, while a second end 301 of the first support block 204₁ is substantially closed and is designed to be secured to the support pipe 202. Although the second end 301 is substantially closed, it does include an aperture 304 formed approximately in the center of the surface of the second end 301.

In particular, the second end 301 of the first support block 204₁ comprises a plurality of plates 302₁-302ₙ (hereinafter collectively referred to as “plates 302”) that are designed to secure the first support block 204₁ to the support pipe 202 in an adjustable manner. In the illustrated embodiment, the second end 301 of the first support block 204₁ comprises two plates: a first plate 302₁ and a second plate 302_{g}.

FIG. 5 is a plan view illustrating one embodiment of the first plate 302₁ illustrated in FIGS. 3-4. The second plate 302, is substantially identical to the first plate 302₁ illustrated in FIG. 5. As illustrated, the first plate 302₁ comprises a rectangular plate having a substantially flat surface 500. The dimensions of the first plate 302₁ are defined at least by a length, l, and a width, w. In one embodiment, the length, l, of the first plate 302₁ is slightly smaller than the cross-sectional length of a side of first support block 204₁. For instance, the length, l, of the first plate 302₁ is sized such that the first plate 302₁ fits securely within a lip 306 extending around a perimeter of the second end 301 of the first support block 204₁. The width, w, of the first plate 302₁ is shorter than the length, l, of the first plate 302₁.

As also illustrated, the first plate 302₁ comprises an aperture 502 formed within the surface 500. In one embodiment, the aperture 502 has a substantially elongated (e.g., oblong) shape. In one embodiment, the aperture 502 is positioned over the aperture 304 in the second end 301 of the first support block 204₁.

Referring back to FIGS. 3-4, the first plate 302₁ is disposed on the exterior side of the second end 301 of the first support block 204₁ (i.e., exterior to the hollow body of the first support block 204₁), while the second plate 302, is disposed on the interior side of the second end 301 (i.e., interior to the hollow body of the first support block 204₁). In one embodiment, the first plate 302₁ and the second plate 302, are positioned substantially perpendicular relative to each other (i.e., so that they form a cross shape), as illustrated in FIG. 3.

Finally, a fastener 310 is disposed through the second end 301 of the first support block 204₁. The faster 310 passes through the apertures 402 in the plates 302, as well as through the aperture 304 in the second end 301 of the first support block 204₁ and an aperture 310 in the support pipe 202. This configuration is clearly illustrated in FIG. 4. In this manner, the first support block 204₁ is securely fastened to the support pipe 202. In one embodiment, the fastener 310 is an adjustable fastener that can be easily loosened and tightened, such as a nut and bolt fastener. Thus, the plates 302 and fastener 310 together form an adjustment mechanism that is formed integrally with the first support block 204₁ (i.e., the adjustment mechanism is also part of the mechanism by which the first support block 204₁ is secured to the support pipe).

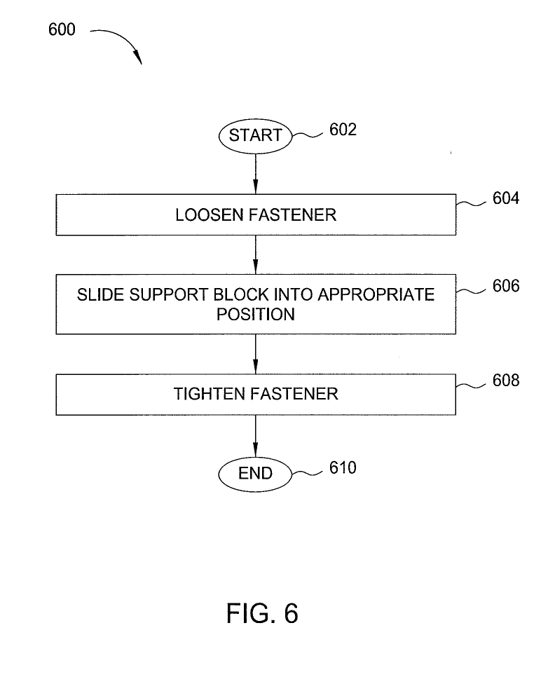

The design of the first support block 204₁ allows the position of a post placed over the post mount 200 to be adjusted so that it is plumb in the vertical direction. FIG. 6, for example, is a flow diagram illustrating one embodiment of a method 600 for adjusting a post mount so that a post placed over the post mount is plumb in the vertical direction. For ease of explanation, discussion of the method 600 makes reference to elements of the post mount 200 illustrated in FIGS. 2-5.

The method 600 is initiated in step 602. In step 604, the fastener 308 is loosened until the first support block 204₁ is able to slide along the apertures 502 that are formed in the plates 302.

In step 606, the first support block 204₁ is slid into an appropriate position (i.e., so that it is plumb in the vertical direction). Because the plates 302 are arranged in a cross pattern (i.e., so that their respective apertures 502 are substantially perpendicular to each other), the first support block 204₁ can be slid freely in substantially any direction. In particular, the elongated apertures 502 in the plates 302 define paths along which the first support block 204₁ can be slid. The position of the first support block 204₁ with respect to the support pipe 202 is therefore easily adjusted.

In step 608, the fastener 308 is tightened. This secures the first support block 204₁ into place and secures the post mount 600 in the plumb position. The method 600 then ends in step 610.

The design of the first support block 204₁ therefore allows the post mount 200 (and any post positioned over the post mount 200) to be plumbed quickly and easily with the turn of a single fastener. Moreover, because the means for plumbing the post mount 200 is built into the post mount itself (i.e., built into the first support block 204₁), there is no need for secondary leveling or plumbing devices, which reduces the overall costs of constructing a railing system. Additionally, the design of the first support block 204₁ allows the post mount 200 to be easily plumbed even after installation of the railing system.

It is noted that FIGS. 2-4 illustrate only one possible relative orientation of the first support block 204₁ and the support pipe 200. Specifically, FIG. 204 illustrate a configuration in which the support pipe 202 passes through the first end 300 of the first support block 204₁ before being secured to the second end 301 of the first support block 204₁. In other embodiments, the first support block 204₁ could be flipped (e.g., “upside down”) so that the support pipe does not pass through the first end 300 of the first support block 204₁. This configuration may be preferable for installation of taller posts (as the full height of the first support block 204₁ is added to the overall height of the post mount 200), but still allows for plumbing of the post mount 200 in the same manner.

Although various embodiments which incorporate the teachings of the present invention have been shown and described in detail herein, those skilled in the art can readily devise many other varied embodiments that still incorporate these teachings.

1. A support block for use in securing a post mount, the support block comprising:
a body having a first end and a second end; and
an adjustment mechanism formed integrally with the second end of the body, the adjustment mechanism comprising:
a first plate disposed on an exterior side of the second end; and
a second plate disposed on an interior side of the second end,
wherein the adjustment mechanism allows the post mount to be plumbed in a vertically aligned manner.

2. The support block of claim 1, wherein:
the first plate has a first aperture formed therein;
the second plate has a second aperture formed therein; and
the first plate and the second plate are positioned in a substantially perpendicular manner relative to each other.

3. The support block of claim 2, wherein each of the first aperture and the second aperture has an elongated shape.

4. The support block of claim 2, further comprising:
an adjustable fastener disposed through the first aperture and the second aperture.

5. The support block of claim 1, wherein the support block is formed of a rigid plastic or composite.

6. The support block of claim 1, wherein an interior of the support block is substantially hollow.

7. The support block of claim 1, wherein the first end is substantially open.

8. A post mount, comprising:
a support pipe having a first end and a second end, the first end being fixed to a support surface; and
a support block secured to the second end of the support pipe, the support block comprising:
a body having a first end and a second end; and
an adjustment mechanism formed integrally with the second end of the body, the adjustment mechanism comprising:
a first plate disposed on an exterior side of the second end; and
a second plate disposed on an interior side of the second end,
wherein the adjustment mechanism allows the post mount to be plumbed in a vertically aligned manner.

9. The post mount of claim 8, wherein:
the first plate has a first aperture formed therein;
the second plate has a second aperture formed therein; and
the first plate and the second plate are positioned in a substantially perpendicular manner relative to each other.

10. The post mount of claim 9, wherein each of the first aperture and the second aperture has an elongated shape.

11. The post mount of claim 9, wherein the support block further comprises:
an adjustable fastener disposed through the first aperture and the second aperture.

12. The post mount of claim 8, wherein the support block is formed of a rigid plastic or composite.

13. The post mount of claim 8, wherein an interior of the support block is substantially hollow.

14. The post mount of claim 8, wherein the first end of the support block is substantially open.

15. The post mount of claim 14, wherein the second end of the support pipe passes through the first end of the support block.

16. The post mount of claim 14, wherein the support block is secured to the second end of the support pipe without passing the second end of the support pipe through the second end of the support block.

17. A method for plumbing a post mount, the post mount comprising a support pipe coupled to a support block, the method comprising:
loosening a single fastener by which the support pipe is secured to the support block;
adjusting a position of the support block with respect to the support pipe until the post mount is plumbed in a vertically aligned manner, wherein the adjusting is performed using an adjustment mechanism comprising:
a first plate disposed on an exterior side of an end of the support block; and
a second plate disposed on an interior side of the end of the support block; and
tightening the fastener.

18. The method of claim 17, wherein the support block is coupled to a first end of the support pipe, and a second end of the support pipe is fixed to a support surface.

19. The method of claim 17, wherein the adjusting comprises:
sliding the support block along at least one path defined by at least one aperture through which the fastener is disposed.

20. The method of claim 17, wherein the adjusting comprises:
moving the support block into a position such that the post mount is plumb in a vertical direction.
